(19) United States
(12) Patent Application Publication
(10) Pub. No.: US 2026/0117063 A1
(43) Pub. Date: Apr. 30, 2026

(54) POLYCARBONATE COMPOSITION

(71) Applicant: Covestro Deutschland AG, Leverkusen (DE)

(72) Inventors: Zhenyu Huang, Shanghai (CN); Hao Han, Shanghai (CN)

(21) Appl. No.: 19/163,429

(22) PCT Filed: Mar. 14, 2024
(86) PCT No.: PCT/EP2024/056824

§ 371 Date: Sep. 9, 2025

(30) Foreign Application Priority Data
Mar. 24, 2023 (WO) PCT/CN2023/083541
Apr. 19, 2023 (EP) 23168631.2

(51) Int. Cl. C08L 69/00; C08K 5/523

(52) U.S. Cl. CPC C08L 69/00; C08K 5/523; C08L 2201/02; C08L 2205/025; C08L 2205/035

(57) ABSTRACT

The present invention relates to a polycarbonate composition comprising the following components, relative to the total weight of the composition A) 63-81 wt. % of an aromatic polycarbonate,
B) 13-20 wt. % of a phosphorus flame retardant,
C) 4-12 wt. % of impact modifiers containing 1-7 wt. % of a first impact modifier and 1-7 wt. % a second impact modifier, wherein the first impact modifier is acrylonitrile-butadiene-styrene, and the second impact modifier is selected from methyl methacrylate-butadiene-styrene and silicone-acrylic rubber based impact modifiers,
D) 1-6 wt. % of a mineral filler, and
E) 0.05-0.09 wt. % of polytetrafluoroethylene.

The present invention also relates to a shaped article made from the composition. The polycarbonate composition according to the present invention has a good combination of flame retardancy and impact strength.

### TECHNICAL FIELD

The present invention relates to a polycarbonate (PC) composition. In particular, the present invention relates to a polycarbonate composition and a shaped article made from the same.

### BACKGROUND ART

In the flame retardant (FR) polymeric materials, polytetrafluoroethylene (PTFE) is usually used as anti-dripping agent, along with other flame retardant agents, to ensure passing flame retardancy standards such as UL94 VX and 5V series. During polymer processing such as compounding and injection molding, PTFE will form fiber structure in the polymer to enhance the melt strength during burning, therefore prevent dripping and potential spread of the fire. In UL94 V0 and 5V (5VB and 5VA) tests, dripped is not allowed according to the criteria. In most flame retardant polycarbonate compositions, usually 0.2-0.5 wt. % of PTFE is needed to pass V0 and 5V test. Too low PTFE loading will lead to the flame retardant test failure due to dripping. For example, U.S. Pat. No. 8,524,824 discloses a resin composition comprising (A) 75 to 99.98 wt % of an aromatic polycarbonate resin, (B) 0.01 to 5 wt % of a mixture of polytetrafluoroethylene particles and an organic polymer and (C) 0.01 to 20 wt % of a flame retardant. it discloses in Example 1 that when the PTFE content is lower than 0.1 wt %, the composition has a flame-retardant level of V2 at a thickness of 1.6 mm.

In spite of the advantages PTFE brings to flame retardancy, certain restrictions have been given by some regional regulations due to the fact that PTFE contains fluorine. This is mainly based on the concern of the effect of fluorine and fluorine-containing compounds on environment and eco-system. The DIN/VDE standard restricts fluorine content less than 0.1%, which corresponds PTFE content of 0.13%. In 2020, five European countries proposed a restriction on the use of PFAS (Per- & PolyFluoro Alkyl Substances) including PTFE. Therefore PTFE can be possibly put in the Substances of Very High Concern (SVHC) list of REACH in near future. In that case, a maxium amount of 1000 ppm may be given to PTFE in polymer compositions and the articles made thereform. Such a low PTFE content limit poses a big challenge to developing flame retardant materials that can meet current FR testing standards.

In addition, high PTFE content in compositions sometimes also leads to surface defects such as peppering issue due to the aggregation of PTFE. This is mainly caused by the incompatibility between polycarbonate and PTFE and also the mismatch of their refractive index. Thus, it is desired to have polycarbonate compositions with a low PTFE content to give good surface quality for the articles prepared therefrom, especially for the high gloss applications.

Meanwhile, it is also desired to develop polycarbonate compositions having good anti-impact performance.

Therefore, there is a need for polycarbonate compositions with a relatively low polytetrafluoroethylene content, which can be used to prepare articles with a good combination of flame retardancy and impact strength.

### SUMMARY OF THE INVENTION

One object of the present application is thus to provide a polycarbonate composition which has a relatively low polytetrafluoroethylene content and can be used to prepare articles having a good combination of flame retardancy and impact strength.

Another object of the present application is to provide an article which has a good combination of flame retardancy and impact strength.

In a first aspect, the present invention provides a polycarbonate composition comprising the following components, relative to the total weight of the composition:
A) 63-81 wt. % of an aromatic polycarbonate,
B) 13-20 wt. % of a phosphorus flame retardant,
C) 4-12 wt. % of impact modifiers containing 1-7 wt. % of a first impact modifier and 1-7 wt. % a second impact modifier, wherein the first impact modifier is acrylonitrile-butadiene-styrene, and the second impact modifier is selected from methyl methacrylate-butadiene-styrene and silicone-acrylic rubber based impact modifiers,
D) 1-6 wt. % of a mineral filler, and
E) 0.05-0.09 wt. % of polytetrafluoroethylene.

The inventors have discovered unexpectedly that the composition according to the present invention can be used to prepare articles having a good combination of flame retardancy and impact strength. For example, the articles prepared with the composition according to the present invention have an impact strength more than 20 kJ/m² as determined according to ISO 180/A:2000. Meanwhile, the articles prepared with the composition according to the present invention have a flame retardancy of V0 as measured according to UL94: 2013 and can pass 5VB standard.

In a second aspect, the present invention provides a shaped article made from a polycarbonate composition according to the first aspect of the present invention.

In a third aspect, the present invention provides a process for preparing the shaped article mentioned above, comprising injection moulding, extrusion moulding, blow moulding or thermoforming the polycarbonate composition according to the first aspect of the present invention.

Other subjects and characteristics, aspects and advantages of the present invention will emerge even more clearly on reading the description and the examples that follow.

### DETAILED DESCRIPTION OF THE INVENTION

In that which follows and unless otherwise indicated, the limits of a range of values are included within this range, in particular in the expressions “between . . . and . . . ” and “from . . . to . . . ”.

Unless defined otherwise, all technical and scientific terms used herein have the same meaning as commonly understood by one of ordinary skill in the art to which the present invention pertains. When the definition of a term in the present description conflicts with the meaning as commonly understood by those skilled in the art the present invention belongs to, the definition described herein shall apply.

Throughout the instant application, the term “comprising” is to be interpreted as encompassing all specifically mentioned features as well optional, additional, unspecified ones. As used herein, the use of the term “comprising” also discloses the embodiment wherein no features other than the specifically mentioned features are present (i.e. “consisting of”).

Unless otherwise specified, all numerical values expressing amount of ingredients and the like which are used in the description and claims are to be understood as being modified by the term “about”.

### Component A

The polycarbonate composition according to the present invention comprises an aromatic polycarbonate.

According to the invention, “aromatic polycarbonates” or else just “polycarbonates” is to be understood as meaning both homopolycarbonates and copolycarbonates, in particular aromatic ones. These polycarbonates may be linear or branched in known fashion. According to the invention, mixtures of polycarbonates may also be used.

Aromatic polycarbonates selected in accordance with the invention preferably have weight-average molecular weights M_{w} of 15 000 to 40 000 g/mol, more preferably of 16 000 to 34 000 g/mol, even more preferably of 17 000 to 33 000 g/mol, most preferably of 19 000 to 32 000 g/mol. The values for M_{w} here are determined by a gel permeation chromatography, calibrated against bisphenol A polycarbonate standards using dichloromethane as eluent, calibration with linear polycarbonates (made of bisphenol A and phosgene) of known molar mass distribution from PSS Polymer Standards Service GmbH, Germany; calibration according to method 2301-0257502-09D (2009 Edition in German) from Currenta GmbH & Co. OHG, Leverkusen. The eluent is dichloromethane. Column combination of crosslinked styrene-divinylbenzene resins. Diameter of analytical columns: 7.5 mm; length: 300 mm. Particle sizes of column material: 3 μm to 20 μm. Concentration of solutions: 0.2% by weight. Flow rate: 1.0 ml/min, temperature of solutions: 30° C. Detection using a refractive index (RI) detector.

The polycarbonates are preferably produced by the interfacial process or the melt transesterification process, which have been described many times in the literature.

With regard to the interfacial process reference is made for example to H. Schnell, “Chemistry and Physics of Polycarbonates”, Polymer Reviews, Vol. 9, Interscience Publishers, New York 1964 p. 33 et seq., to Polymer Reviews, Vol. 10, “Condensation Polymers by Interfacial and Solution Methods”, Paul W. Morgan, Interscience Publishers, New York 1965, Chapt. VIII, p. 325, to Dres. U. Grigo, K. Kircher and P. R- Müller “Polycarbonate” in Becker/Braun, Kunststoff-Handbuch, Volume 3/1, Polycarbonate, Polyacetale, Polyester, Celluloseester, Carl Hanser Verlag Munich, Vienna 1992, pp. 118-145 and also to EP 0 517 044 A1.

The melt transesterification process is described, for example, in the “Encyclopedia of Polymer Science”, Vol. 10 (1969), Chemistry and Physics of Polycarbonates, Polymer Reviews, H. Schnell, Vol. 9, John Wiley and Sons, Inc. (1964), and in patent specifications DE 10 31 512 A and U.S. Pat. No. 6,228,973 B1.

Particulars pertaining to the production of polycarbonates are disclosed in many patent documents spanning approximately the last 40 years. Reference may be made here by way of example to Schnell, “Chemistry and Physics of Polycarbonates”, Polymer Reviews, Volume 9, Interscience Publishers, New York, London, Sydney 1964, to D. Freitag, U. Grigo, P. R. Müller, H. Nouvertné, BAYER AG, “Polycarbonates” in Encyclopedia of Polymer Science and Engineering, Volume 11, Second Edition, 1988, pages 648-718, and finally to U. Grigo, K. Kirchner and P. R. Müller “Polycarbonate” in Becker/Braun, Kunststoff-Handbuch, Volume 3/1, Polycarbonate, Polyacetale, Polyester, Celluloseester, Carl Hanser Verlag Munich, Vienna 1992, pages 117-299.

The production of aromatic polycarbonates is effected for example by reaction of dihydroxyaryl compounds with carbonic halides, preferably phosgene, and/or with aromatic dicarboxyl dihalides, preferably benzenedicarboxyl dihalides, by the interfacial process, optionally using chain terminators and optionally using trifunctional or more than trifunctional branching agents, production of the polyester carbonates being achieved by replacing a portion of the carbonic acid derivatives with aromatic dicarboxylic acids or derivatives of the dicarboxylic acids, specifically with aromatic dicarboxylic ester structural units according to the carbonate structural units to be replaced in the aromatic polycarbonates. Preparation via a melt polymerization process by reaction of dihydroxyaryl compounds with, for example, diphenyl carbonate is likewise possible.

Dihydroxyaryl compounds suitable for the production of polycarbonates are for example hydroquinone, resorcinol, dihydroxydiphenyls, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl)diisopropylbenzenes, phthalimidines derived from derivatives of isatin or phenolphthalein and the ring-alkylated, ring-arylated and ring-halogenated compounds thereof.

Preferred dihydroxyaryl compounds are 4,4′-dihydroxydiphenyl, 2,2-bis(4-hydroxyphenyl)propane (bisphenol A), 2,4-bis(4-hydroxyphenyl)-2-methylbutane, 1,1-bis(4-hydroxyphenyl)-p-diisopropylbenzene, 2,2-bis(3-methyl-4-hydroxyphenyl)propane, dimethylbisphenol A, bis(3,5-dimethyl-4-hydroxyphenyl)methane, 2,2-bis(3,5-dimethyl-4-hydroxyphenyl)propane, bis(3,5-dimethyl-4-hydroxyphenyl)sulfone, 2,4-bis(3,5-dimethyl-4-hydroxyphenyl)-2-methylbutane, 1,1-bis(3,5-dimethyl-4-hydroxyphenyl)-p-diisopropylbenzene and 1,1-bis(4-hydroxyphenyl)-3,3,5-trimethylcyclohexane and also the bisphenols (I) to (III)

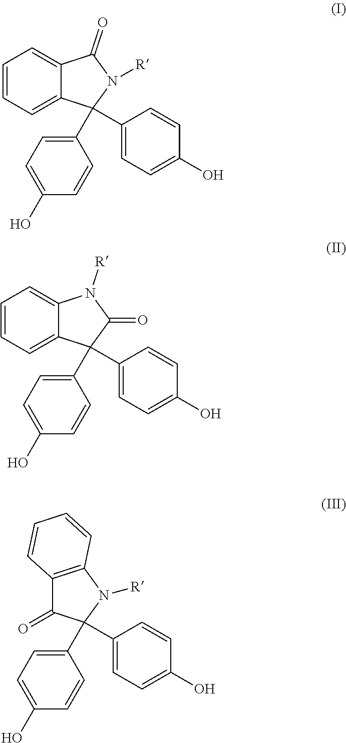

in which R′ in each case stands for C₁- to C₄-alkyl, aralkyl or aryl, preferably for methyl or phenyl, very particularly preferably for methyl.

Particularly preferred dihydroxyaryl compounds are 2,2-bis(4-hydroxyphenyl)propane (bisphenol A), 2,2-bis(3,5-dimethyl-4-hydroxyphenyl)propane, 1,1-bis(4-hydroxyphenyl)cyclohexane, 1,1-bis(4-hydroxyphenyl)-3,3,5-trimethylcyclohexane, 4,4′-dihydroxybiphenyl, and dimethylbisphenol A and also the diphenols of formulae (I), (II) and (III).

These and other suitable dihydroxyaryl compounds are described for example in U.S. Pat. Nos. 3,028,635 A, 2,999,825 A, 3,148,172 A, 2,991,273 A, 3,271,367 A, 4,982,014 A und 2,999,846 A, in DE 1 570 703 A, DE 2063 050 A, DE 2 036 052 A, DE 2 211 956 A and U.S. Pat. No. 2,999,846 A, in DE 1 570 703 A, DE 2063 050 A, DE 2 036 052 A, DE 2 211 956 A and DE 3 832 396 A, in FR 1 561 518, in the monograph “H. Schnell, Chemistry and Physics of Polycarbonates, Interscience Publishers, New York 1964” and also in JP 62039/1986 A, JP 62040/1986 A and JP 105550/1986 A.

In the case of homopolycarbonates only one dihydroxyaryl compound is used; in the case of copolycarbonates two or more dihydroxyaryl compounds are used. The dihydroxyaryl compounds employed, similarly to all other chemicals and assistants added to the synthesis, may be contaminated with the contaminants from their own synthesis, handling and storage. However, it is desirable to use raw materials of the highest possible purity.

Suitable carbonic acid derivatives are for example phosgene and diphenyl carbonate.

Suitable chain terminators that may be used in the production of polycarbonates are monophenols. Suitable monophenols are for example phenol itself, alkylphenols such as cresols, p-tert-butylphenol, cumylphenol and mixtures thereof.

Preferred chain terminators are the phenols mono- or polysubstituted by linear or branched C₁-C₃₀ alkyl radicals, preferably unsubstituted or substituted by tert-butyl. Particularly preferred chain terminators are phenol, cumylphenol and/or p-tert-butylphenol.

The amount of chain terminator to be employed is preferably 0.1 to 5 mol % based on the moles of diphenols employed in each case. The addition of the chain terminators may be effected before, during or after the reaction with a carbonic acid derivative.

Suitable branching agents are the trifunctional or more than trifunctional compounds familiar in polycarbonate chemistry, in particular those having three or more than three phenolic OH groups. Suitable branching agents are for example 1,3,5-tri(4-hydroxyphenyl)benzene, 1,1,1-tri(4-hydroxyphenyl)ethane, tri(4-hydroxyphenyl)phenylmethane, 2,4-bis(4-hydroxyphenylisopropyl)phenol, 2,6-bis(2-hydroxy-5′-methylbenzyl)-4-methylphenol, 2-(4-hydroxyphenyl)-2-(2,4-dihydroxyphenyl)propane, tetra(4-hydroxyphenyl)methane, tetra(4-(4-hydroxyphenylisopropyl)phenoxy)methane and 1,4-bis((4′,4″-dihydroxytriphenyl)methyl)benzene and 3,3-bis(3-methyl-4-hydroxyphenyl)-2-oxo-2,3-dihydroindole. The amount of the branching agents for optional employment is preferably 0.05 mol % to 2.00 mol %, based on moles of dihydroxyaryl compounds used in each case. The branching agents may be either initially charged together with the dihydroxyaryl compounds and the chain terminators in the aqueous alkaline phase or added dissolved in an organic solvent before the phosgenation. In the case of the transesterification process the branching agents are employed together with the dihydroxyaryl compounds.

Particularly preferred polycarbonates are the homopolycarbonate based on bisphenol A, the homopolycarbonate based on 1,1-bis(4-hydroxyphenyl)-3,3,5-trimethylcyclohexane, 4,4′-dihydroxybiphenyl, and the copolycarbonates based on the two monomers bisphenol A and 1,1-bis(4-hydroxyphenyl)-3,3,5-trimethylcyclohexane and also homo- or copolycarbonates derived from the diphenols of formulae (I), (II) and (Ill)

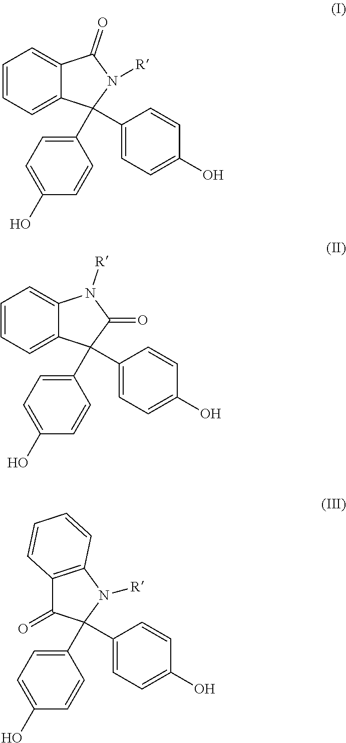

in which R′ in each case stands for C₁- to C₄-alkyl, aralkyl or aryl, preferably for methyl or phenyl, very particularly preferably for methyl.

Preferred are also polycarbonates for the production of which dihydroxyaryl compounds of the following formula (1a) have been used:

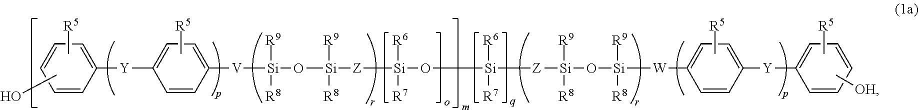

wherein
R⁵ stands for hydrogen or C₁- to C₄-alkyl, C₁- to C₄-alkoxy, preferably for hydrogen or methyl or methoxy particularly preferably for hydrogen,
R⁶, R⁷, R⁸ and R⁹ mutually independently stand for C₆- to C₁₂-aryl or C₁- to C₄-alkyl, preferably phenyl or methyl, in particular for methyl,
Y stands for a single bond, SO₂—, —S—, —CO—, —O—, C₁- to C₆-alkylene, C₂- to C₅-alkylidene, C₆- to C₁₂-arylene, which can optionally be condensed with further aromatic rings containing hetero atoms, or for a C₅- to C₆-cycloalkylidene residue, which can be singly or multiply substituted with C₁- to C₄-alkyl, preferably for a single bond, —O—, isopropylidene or for a C₅- to C₆-cycloalkylidene residue, which can be singly or multiply substituted with C₁- to C₄-alkyl,
V stands for oxygen, C₂- to C₆-alkylene or C₃- to C₆-alkylidene, preferably for oxygen or C₃-alkylene,
p, q and r mutually independently each stand 0 or 1,
if q=0, W is a single bond, if q=1 and r=0 is, W stands for —O—, C₂- to C₆-alkylene or C₃- to C₆-alkylidene, preferably for —O— or C₃-alkylene,
if q=1 and r=1, W and V mutually independently stand for C₂- to C₆-alkylene or C₃- to C₆-alkylidene, preferably for C₃ alkylene,
Z stands for C₁- to C₆-alkylene, preferably C₂-alkylene,
o stands for an average number of repeating units from 10 to 500, preferably 10 to 100 and
m stands for an average number of repeating units from 1 to 10, preferably 1 to 6, particularly preferably 1.5 to 5.

It is also possible to use dihydroxyaryl compounds, in which two or more siloxane blocks of general formula (1a) are linked via terephthalic acid and/or isophthalic acid under formation of ester groups.

Especially preferable are (poly)siloxanes of the formulae (2) and (3)

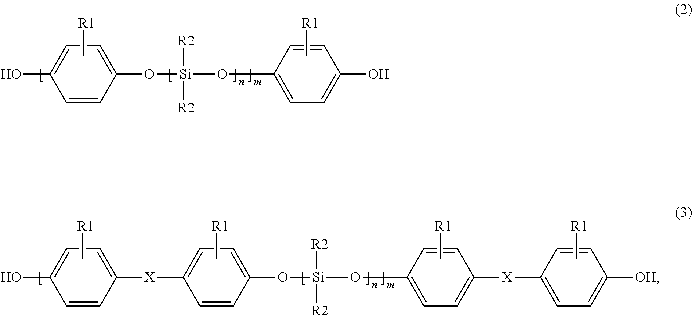

wherein R¹ stands for hydrogen, C₁- to C₄-alkyl, preferably for hydrogen or methyl and especially preferably for hydrogen,
R² mutually independently stand for aryl or alkyl, preferably for methyl,
X stands for a single bond, —SO₂—, —CO—, —O—, —S—, C₁- to C₆-alkylene, C₂- to C₅-alkylidene or for C₆- to C₁₂-arylene, which can optionally be condensed with further aromatic rings containing hetero atoms,
X stands for a single bond, —SO₂—, —CO—, —O—, —S—, C₁- to C₆-alkylene, C₂- to C₅-alkylidene, C₅- to C₁₂-cycloalkylidene or for C₆- to C₁₂-arylene, which can optionally be condensed with further aromatic rings containing hetero atoms,
X preferably stands for a single bond, isopropylidene, C₅- to C₁₂-cycloalkylidene or oxygen, and especially preferably stands for isopropylidene,
n means an average number from 10 to 400, preferably 10 and 100, especially preferably 15 to 50 and
m stands for an average number from 1 to 10, preferably 1 to 6 and especially preferably from 1.5 to 5.

Also preferably the siloxane block can be derived from one of the following structures:

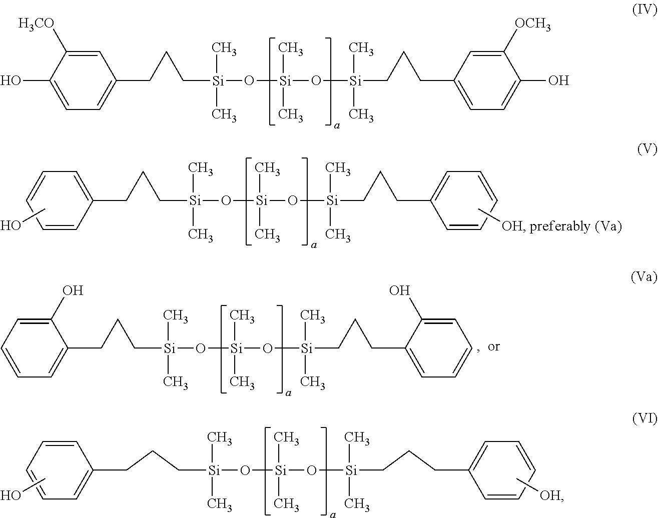

wherein a in formulae (IV), (V) und (VI) means an average number from 10 to 400, preferably from 10 to 100 and especially preferably from 15 to 50.

It is equally preferable, that at least two of the same or different siloxane blocks of the general formulae (IV), (V) or (VI) are linked via terephthalic acid and/isophthalic acid under formation of ester groups.

It is also preferable, if p=0 in formula (1a), V stands for C₃-alkylene,
if r=1, Z stands for C₂-alkylene, R⁸ and R⁹ stand for methyl,
if q=1, W stands for C₃-alkylene,
if m=1, R⁵ stands for hydrogen or C₁- to C₄-alkyl, preferably for hydrogen or methyl, R⁶ and R⁷ mutually independently stand for C₁- to C₄-alkyl, preferably methyl, and o stands for 10 to 500.

Copolycarbonates with monomer units of the general formula (1a), in particular with bisphenol A, and in particular the production of those copolycarbonates are described in WO 2015/052106 A2.

As examples of aromatic polycarbonate suitable for the present invention, mention can be made of those produced from bisphenol A and phosgene, and sold under the trade name Makrolon® 2400, Makrolon® 2600, Makrolon® 2800, Makrolon® 3100 by Covestro Co., Ltd.

The aromatic polycarbonate is present in the composition according to the present invention in an amount ranging from 63 wt. % to 81 wt. %, preferably from 65 wt. % to 80 wt. %, more preferably from 66 wt. % to 76 wt. %, relative to the total weight of the composition.

### Component B

The polycarbonate composition of the present invention comprise a phosphorous flame retardant.

Preferably, the phosphorus flame retardant suitable for use in the composition according to the present invention are selected from monomeric and oligomeric phosphoric and phosphonic acid esters, and mixtures thereof.

Preferred monomeric and oligomeric phosphoric and phosphonic acid esters are phosphorus compounds of formula (A):

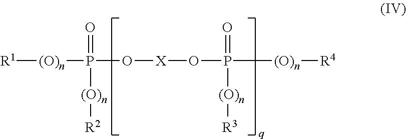

wherein
R¹, R², R³ and R⁴, independently of one another, each denotes optionally halogenated C1-C8 alkyl, C5-C6 cycloalkyl, C6-C20 aryl or C7-C12 aralkyl each optionally substituted by alkyl, preferably C1-C4 alkyl, and/or halogen, preferably chlorine, bromine,
n independently of one another, denotes 0 or 1,
q denotes a number ranging from 0 to 30, and
X denotes a mononuclear or polynuclear aromatic residue with 6 to 30 carbon atoms or a linear or branched aliphatic residue with 2 to 30 carbon atoms, which can be OH-substituted and can contain up to eight ether bonds.

Preferably, R¹, R², R³ and R⁴, independently of one another, each denotes C1-C4 alkyl, phenyl, naphthyl, or phenyl C1-C4 alkyl, wherein the aromatic groups R¹, R², R³ and R⁴ can themselves be substituted with halogen and/or alkyl groups, preferably chlorine, bromine and/or C1-C4 alkyl. Particularly preferred aryl residues are cresyl, phenyl, xylenyl, propylphenyl or butylphenyl and the corresponding brominated and chlorinated derivatives thereof.

Preferably, X in formula (A) denotes a mononuclear or polynuclear aromatic residue with 6 to 30 carbon atoms.

More preferably, X, is derived from resorcinol, hydroquinone, bisphenol A or diphenylphenol. Particularly preferably, X is derived from bisphenol A.

Preferably, n is equal to 1.

Preferably, q denotes a number from 0 to 20, particularly from 0 to 10, and in the case that a mixture of phosphorus compounds of the general formula (A) are used, a average value from 0.8 to 5.0, preferably 1.0 to 3.0, more preferably 1.05 to 2.00, and particularly preferably from 1.08 to 1.60.

Phosphorus compounds of formula (A) are in particular tributyl phosphate, triphenyl phosphate, tricresyl phosphate, diphenyl cresyl phosphate, diphenyl octyl phosphate, diphenyl-2-ethylcresyl phosphate, tri(isopropylphenyl)phosphate, resorcinol bridged oligophosphate and bisphenol A bridged oligophosphate.

Thus, preferably, the phosphorous-containing flame retardant is selected from tributyl phosphate, triphenyl phosphate, tricresyl phosphate, diphenyl cresyl phosphate, diphenyl octyl phosphate, diphenyl-2-ethylcresyl phosphate, tri(isopropylphenyl)phosphate, resorcinol bridged oligophosphate, bisphenol A bridged oligophosphate, and combinations thereof.

More preferably, the phosphorous-containing flame retardant is selected from bisphenol A bis(diphenyl phosphate), tetraphenyl resorcinol diphosphate (RDP), [1,3-phenylene-tet-rakis(2,6-dimethylphenyl)phosphate], and combinations thereof.

The phosphorus compounds of formula (A) are known (cf. e.g. EP-A 0 363 608, EP-A 0 640 655) or can be produced by known methods in an analogous manner (e.g. Ullmanns Enzyklopadie der technischen Chemie, vol. 18, pp. 301 ff. 1979; Houben-Weyl, Methoden der organischen Chemie, vol. 12/1, p. 43; Beilstein vol. 6, p. 177).

It is also possible to use mixtures of phosphates having different chemical structures and/or having the same chemical structure and different molecular weights as component D IN the composition according to the present invention.

The phosphorous flame retardant is present in an amount ranging from 13 wt. % to 20 wt. %, preferably from 14 wt. % to 18 wt. %, relative to the total weight of the polycarbonate composition.

### Component C

According to the first aspect, the polycarbonate composition according to the present invention comprises a first impact modifier, which is acrylonitrile-butadiene-styrene, and a second impact modifier selected from methyl methacrylate-butadiene-styrene and silicone-acrylic rubber based impact modifiers.

### Acrylonitrile-Butadiene-Styrene

Acrylonitrile-butadiene-styrene (ABS) has a core-shell impact structure, which is described e.g. in DE-OS 2 035 390 or in DE-OS 2 248 242 and in Ullmanns, Enzyklopädie der Technischen Chemie, vol. 19 (1980), p. 280 et seq.

Preferably, acrylonitrile-butadiene-styrene (ABS) comprises 5 wt. % to 95 wt. %, preferably 8 wt. % to 90 wt. %, in particular 20 wt. % to 85 wt. % of units derived from acrylonitrile and styrene, and 95 wt. % to 5 wt. %, preferably 92 wt. % to 10 wt. %, in particular 80 wt. % to 15 wt. % of units derived from butadiene, based on the weight of acrylonitrile-butadiene-styrene.

More preferably, acrylonitrile-butadiene-styrene (ABS) comprises 5 wt. % to 20 wt. % of units derived from acrylonitrile, 20 wt. % to 55 wt. % of units derived from styrene, and 75 wt. % to 30 wt. % of units derived butadiene, based on the weight of acrylonitrile-butadiene-styrene.

As commercial products of acrylonitrile-butadiene-styrene can be used in the present invention, mention can be made to ABS HRG powder P60 available from Styrolution, produced by emulsion polymerisation of 42-45 wt. %, based on the ABS polymer, of a mixture of 27 wt. % acrylonitrile and 73 wt. % styrene in the presence of 55-58 wt. %, based on the ABS polymer, of a crosslinked polybutadiene rubber (the average particle diameter d₅₀ is 0.3 μm).

The first impact modifier, i.e., acrylonitrile-butadiene-styrene is present in the composition according to the present invention in an amount ranging from 1 wt. % to 7 wt. %, preferably from 2 wt. % to 6 wt. %, relative to the total weight of the polycarbonate composition.

### Methyl Methacrylate-Butadiene-Styrene

Methyl methacrylate-butadiene-styrene (MBS) has a core-shell impact structure, which is described e.g. in DE-OS 2 035 390 or in DE-OS 2 248 242 and in Ullmanns, Enzyklopädie der Technischen Chemie, vol. 19 (1980), p. 280 et seq.

Preferably, methyl methacrylate-butadiene-styrene (MBS) comprises 5 wt. % to 95 wt. %, preferably 8 wt. % to 90 wt. %, in particular 20 wt. % to 85 wt. % of units derived from methyl methacrylate and styrene, and 95 wt. % to 5 wt. %, preferably 92 wt. % to 10 wt. %, in particular 85 wt. % to 15 wt. % of units derived from butadiene, based on the weight of methyl methacrylate-butadiene-styrene.

More preferably, methyl methacrylate-butadiene-styrene (MBS) comprises 10 wt. % to 35 wt. % of units derived from methyl methacrylate, 5 wt. % to 20 wt. % of units derived from styrene, and 60 wt. % to 85 wt. % of units derived butadiene, based on the weight of methyl methacrylate-butadiene-styrene.

As commercial products of methyl methacrylate-butadiene-styrene can be used in the present invention, mention can be made to Kane Ace M732 available from Japan Kaneka Chemical Co. Ltd, comprising 10 wt. % to 35 wt. % of units derived from methyl methacrylate, 5 wt. % to 10 wt. % of units derived from styrene, and 60 wt. % to 85 wt. % of units derived butadiene, based on the weight of methyl methacrylate-butadiene-styrene.

### Silicone-Acrylic Rubber Based Impact Modifiers

The silicone-acrylate rubber based impact modifier has a core-shell impact structure.

Preferably, the silicone-acrylate rubber based impact modifier comprises,
C.1) 5 wt. % to 90 wt. %, preferably 8 wt. % to 80 wt. %, in particular 10 wt. % to 70 wt. %, of at least one vinyl monomer on
C.2) 95 wt. % to 10 wt. %, preferably 92 wt. % to 20 wt. %, in particular 90 wt. % to 30 wt. %, of one or more silicone-acrylate rubbers as a graft base,
the wt. % is calculated based on the weight of the impact modifier.

The vinyl monomers are used to form polymer chains and these are chemically bonded to the graft substrate.

Preferably, the vinyl monomer C.1 is selected from vinylaromatics and/or vinylaromatics substituted on the nucleus (such as styrene, α-methylstyrene, p-methylstyrene), vinyl cyanides (unsaturated nitriles, such as acrylonitrile and methacrylonitrile), (meth)acrylic acid (C₁-C₈)-alkyl esters, such as methyl methacrylate, ethyl methacrylate, n-butyl acrylate, t-butyl acrylate, and derivatives (such as anhydrides and imides) of unsaturated carboxylic acids, for example maleic anhydride and N-phenylmaleimide.

More preferably, the at least one vinyl monomer C.1 comprises (meth)acrylic acid (C₁-C₈)-alkyl esters or its combination with styrene, α-methylstyrene or p-methylstyrene.

In some embodiments, monomers C.1 is a mixture of
C.1.1) 50 to 99, preferably 60 to 80, especially 70 to 80 parts by weight, based on C.2.1, of vinylaromatics and/or ring-substituted vinylaromatics (such as styrene, □ methylstyrene, p-methylstyrene, p-chlorostyrene) and/or (C1-C8)-alkyl methacrylates, such as methyl methacrylate, ethyl methacrylate, and
C.1.2) 1 to 50, preferably 20 to 40, especially 20 to 30 parts by weight, based on C.2.1, of (C1-C8)-alkyl (meth)acrylates, such as methyl methacrylate, n-butyl acrylate, tert-butyl acrylate, and/or derivatives (such as anhydrides and imides) of unsaturated carboxylic acids, for example maleic anhydride and N-phenylmaleimide.

Preferred monomers C.1.1 are selected from at least one of the monomers styrene, methylstyrene and methyl methacrylate; preferred monomers C.1.2 are selected from at least one of the monomers maleic anhydride and methyl methacrylate. Particularly preferred monomers are C.1.1=C.1.2 methyl methacrylate.

A silicone-acrylate composite rubber or a mixture of different silicone-acrylate composite rubbers can be employed as the graft substrate C.2. These silicone-acrylate composite rubbers are preferably composite rubbers having graft-active sites containing:
C.2.1) 5 wt. %-95 wt. %, preferably 20 wt. % to 80 wt. %, particularly preferably 25 wt. % to 50 wt. %, of silicone rubber proportion, and
C.2.2) 95 wt. % to 5 wt. %, preferably 80 wt. % to 20 wt. %, particularly preferably 75 wt. % to 50 wt. %, of polyalkyl (meth)acrylate rubber proportion,
wherein the two rubber components penetrate one another in the composite rubber and are therefore essentially inseparable.

The particularly preferred proportions of silicone rubber and polyalkyl (meth)acrylate rubber results in a particularly advantageous combination of good mechanical properties, good surface of the component parts and good resistance toward hydrolytic molecular weight degradation and the influence of chemicals.

Silicone-acrylate composite rubbers are known and are described for example in U.S. Pat. No. 5,807,914, EP 430134 and U.S. Pat. No. 4,888,388.

Suitable silicone rubber components C.2.1 of the silicone-acrylate composite rubbers are silicone rubbers having graft-active sites, the production method therefor is described for example in U.S. Pat. Nos. 2,891,920, 3,294,725, DE-A 3 631 540, EP 249964, EP 430134 and U.S. Pat. No. 4,888,388.

The silicone rubber according to C.2.1 is preferably produced by emulsion polymerization in which siloxane monomer units, crosslinking or branching agents and optionally grafting agents are used.

Examples of preferably siloxane monomer for production of silicone rubber include dimethylsiloxane or cyclic organosiloxanes having at least 3 ring members, preferably 3 to 6 ring members, for example and with preference hexamethylcyclotrisiloxane, octamethylcyclotetrasiloxane, decamethylcyclopentasiloxane, dodecamethylcyclohexasiloxane, trimethyltriphenylcyclotrisiloxanes, tetramethyltetraphenylcyclotetrasiloxanes, octaphenylcyclotetrasiloxane.

The organosiloxane monomers may be used alone or in the form of a mixture comprising 2 or more monomers.

Preferably crosslinking agents are silane-based crosslinking agents having a functionality of 3 or 4, particularly preferably 4. Preferred examples include: trimethoxymethylsilane, triethoxyphenylsilane, tetramethoxysilane, tetraethoxysilane, tetra-n-propoxysilane and tetrabutoxysilane. The crosslinking agent can be used alone or in a mixture of two or more. Particular preference is given to tetraethoxysilane.

Examples of grafting agents include β-methacryloyloxyethyl dimethoxymethylsilane, γ-ethacryloyloxypropyl methoxydimethylsilane, γ-methacryloyloxypropyl dimethoxymethylsilane, γ-methacryloyloxypropyl trimethoxysilane, γ-methacryloyloxypropyl ethoxydiethylsilane, γ-methacryloyloxypropyl diethoxymethylsilane, δ-methacryloyloxybutyl diethoxymethylsilane or mixtures thereof.

It is preferable to use 0-20 wt. % of grafting agent based on the total weight of the silicone rubber.

The silicone rubber may be produced by emulsion polymerization as described for example in U.S. Pat. Nos. 2,891,920 and 3,294,725.

Suitable polyalkyl(meth)acrylate rubber components C.2.2 of the silicone-acrylate-composite rubbers may be produced from alkyl methacrylates and/or alkyl acrylates, a crosslinking agent and a grafting agent.

Examples of preferred alkyl methacrylates and/or alkyl acrylates include the C1- to C8-alkyl esters, for example methyl, ethyl, n-butyl, t-butyl, n-propyl, n-hexyl, n-octyl, n-lauryl and 2-ethylhexyl esters; haloalkyl esters, preferably halo-C1-C8-alkyl esters, such as chloroethyl acrylate, and mixtures of these monomers. Particular preference is given to n-butyl acrylate.

Employable crosslinking agents for the polyalkyl(meth)acrylate rubber component of the silicone-acrylate rubber include monomers having more than one polymerizable double bond. Preferred examples of crosslinking monomers are esters of unsaturated monocarboxylic acids having 3 to 8 carbon atoms and unsaturated monohydric alcohols having 3 to 12 carbon atoms or saturated polyols having 2 to 4 OH groups and 2 to 20 carbon atoms, such as ethylene glycol dimethacrylate, propylene glycol dimethacrylate, 1,3-butylene glycol dimethacrylate and 1,4-butylene glycol dimethacrylate. The crosslinking agents can be used alone or in mixtures of at least two crosslinking agents.

Examples of preferred grafting agents include allyl methacrylate, triallyl cyanurate, triallyl isocyanurate or mixtures thereof. Allyl methacrylate may also be used as the crosslinking agent. The grafting agents can be used alone or in mixtures of at least two grafting agents.

The amount of crosslinking agent and grafting agent is 0.1 wt. % to 20 wt. % based on the total weight of the polyalkyl (meth)acrylate rubber component of the silicone-acrylate rubber.

The silicone-acrylate-composite rubber is produced by first producing the silicone rubber of C.2.1 in the form of an aqueous latex. This latex is then enriched with the alkyl methacrylates and/or alkyl acrylates to be used, the crosslinking agent and the grafting agent and a polymerization is performed.

The silicone-acrylate composite graft rubbers are produced by grafting the monomers onto the rubber substrate C.2. This can be carried out using the polymerization methods described in EP 249964, EP430134 and U.S. Pat. No. 4,888,388 for example.

As silicone-acrylate rubber, mention can be made of silicone-C₁-C₈ alkyl acrylate rubber. In particle, silicone-butylacrylate rubber can be mentioned as an example.

Preferably, the silicone-acrylate rubber based impact modifier is selected from (meth)acrylic acid (C₁-C₈)-alkyl ester-grafted silicone-C₁-C₈ alkyl acrylate rubber.

More preferably, the silicone-acrylate rubber based impact modifier is a methyl methacrylate-grafted silicone-butyl acrylate rubber.

As an example of commercially available silicone-acrylate rubber based impact modifier can be used in the present invention, mention can be made of Metablen S-2001, Metablen S-2030, Metablen S-2100, and Metablen® S2130 from Mitsubishi Rayon Co., Ltd.

In some embodiments, methyl methacrylate-grafted silicone-butyl acrylate rubber e.g. Metablen® S2130 and Metablen S2100 are used as a second impact modifier.

The second impact modifier selected from methyl methacrylate-butadiene-styrene and silicone-acrylic rubber based impact modifiers is present in the polycarbonate composition according to the present invention in an amount ranging from 1 wt. % to 7 wt. %, preferably from 2 wt. % to 6 wt. %, relative to the total weight of the polycarbonate composition.

According to some embodiments, the composition comprises from 2 wt. % to 6 wt. % of acrylonitrile-butadiene-styrene and from 2 wt. % to 6 wt. % of of methyl methacrylate-butadiene-styrene.

Accroding to some embodiments, the composition comprises from 2 wt. % to 6 wt. % of acrylonitrile-butadiene-styrene and from 2 wt. % to 6 wt. % of methyl methacrylate-grafted silicone-butyl acrylate rubber.

The total amount of the first impact modifier and the second impact modifier is from 1 wt. % to 12 wt. %, preferably, from 6 wt. % to 10 wt. %, relative to the total weight of the composition according to the present invention.

### Component D

According to the first aspect, the polycarbonate composition according to the present invention comprises at least one mineral filler as component D.

Mineral fillers suitable for the composition of the present invention can be in the form of particles, flakes and fibers.

According to some embodiments, the mineral filler is selected from mica, talc, calcium carbonate, wollastonite, barium sulfate, silica, kaolin, inorganic whiskers, glass microspheres, glass sheets, glass fibers, basalt fibers, carbon fibers, boron nitride, graphite and combinations of two or more thereof. Preferably the mineral filler is selected from mica, talc, wollastonite, silica, kaolin, inorganic whiskers, boron nitride, and combinations of two or more thereof. More preferably, the mineral filler is kaolin.

Particulate and flaky mineral fillers may have an average particle size of 0.1-40 μm, preferably 0.1-15 μm and more preferably 0.1-3 μm. Fibrous mineral fillers may have an average diameter of 1-30 μm and a length-diameter ratio of 4-100, and preferably have an average diameter of 3-20 μm and a length-diameter ratio of 5-30.

Preferred mineral fillers include kaolin having an average particle size of 0.1-2 μm and talc having an average particle size of 0.5-3 μm.

The average particle size refers to the average Stokes equivalent particle size determined by a sedimentation method.

The mineral filler is present in the polycarbonate composition in an amount ranging from 1 wt. % to 6 wt. %, preferably from 1 wt. % to 5 wt. %, relative to the total weight of the polycarbonate composition.

### Component E

According to the first aspect, the polycarbonate composition according to the present invention comprises polytetrafluoroethylene as component E.

Polytetrafluoroethylene can be prepared by known processes, for example by polymerization of tetrafluoroethylene in an aqueous medium with a free radical-forming catalyst, for example sodium, potassium or ammonium peroxodisulfate, at pressures of from 7 kg/cm² to 71 kg/cm² and at temperatures of from 0° C. to 200° C., preferably at temperatures of from 20 to 100° C., for further details see e.g. U.S. Pat. No. 2,393,967.

Preferably, the polytetrafluoroethylene have a density of from 1.2 g/cm³ to 2.3 g/cm³.

More preferably, the polytetrafluoroethylene used according to the invention have mean particle diameters of from 0.05 μm to 20 μm, preferably from 0.08 μm to 10 μm, and density of from 1.2 g/cm³ to 1.9 g/cm³.

Polytetrafluoroethylene can be used alone or as a master batch with a homopolymer or copolymer of styrene or methyl methacrylate.

As an example of commercial products of polytetrafluoroethylene, mention can be made to those sold under the trade name Teflon®, such as Teflon® 30 N by DuPont.

A master batch of polytetrafluoroethylene and styrene-acrylonitrile (SAN) in a weight ratio of 1:1, for example, ADS 5000 available from Chemical Innovation Co., Ltd. Thailand and POLYB FS-200 available from Han Nanotech Co., Ltd, can be used.

The polytetrafluoroethylene is present in the polycarbonate composition in an amount ranging from 0.05 wt. % to 0.09 wt. %, preferably from 0.06 wt. % to 0.08 wt. %, relative to the total weight of the polycarbonate composition.

### Additional Components

In addition to components A-E mentioned above, the polycarbonate compositions according to the present invention can optionally comprise one or more additives conventionally used in polycarbonate compositions as additional components. Such additives are, for example, UV stabilizers, IR stabilizers, heat stabilizers, antistatic agents, pigments (such as carbon black), colorants, lubricants (such as waxes), demoulding agents (such as pentaerythrityl tetrastearate), antioxidants, pH adjusters, flow improvers agents, etc.

The person skilled in the art can select the type of the additives so as not to adversely affect the desired properties of the polycarbonate composition according to the present invention.

In some embodiments, the composition according to the present invention may further comprises, up to 5 wt. %, preferably up to 3 wt. %, more preferably from 0.1 wt. % to 3 wt. %, based on the total weight of composition, an additional component selected from the group consisting of antioxidants, heat stabilizers, demoulding agents, antistatic agents, pigments, pH adjusters, and lubricants.

Preferably, the polycarbonate composition according to the present invention comprises, relative to the total weight of the composition:
A) 66-76 wt. % of an aromatic polycarbonate based on bisphenol A,
B) 14-18 wt. % of a phosphorous flame retardant selected from bisphenol A bis(diphenyl phosphate), tetraphenyl resorcinol diphosphate (RDP), and [1,3-phenylene-tet-rakis(2,6-dimethylphenyl)phosphate],
C) 2-6 wt. % of acrylonitrile-butadiene-styrene and 2-6 wt. % of an impact modifier selected from methyl methacrylate-butadiene-styrene and methyl methacrylate-grafted silicone-butyl acrylate rubber,
D) 1-5 wt. % of kaolin, and
E) 0.05-0.09 wt. % of polytetrafluoroethylene.

The total amount of components A)-E) as defined above is from 90 wt. % to 100 wt. %, preferably from 95 wt. % to 100 wt. %, more preferably from 97 wt. % to 100 wt. %, based on the total weight of the polycarbonate composition according to the present invention.

### Preparation of the Polycarbonate Composition

The polycarbonate composition according to the present invention can be in the form of, for example, pellets.

The polycarbonate composition according to the present invention demonstrates a good processing behaviour and can be prepared by a variety of methods involving intimate admixing of the materials desired in the composition.

For example, the materials desired in the composition are first blended in a high speed mixer. Low shear processes, including but not limited to hand mixing, can also accomplish this blending. The blend is then fed into the throat of a twin-screw extruder via a hopper. Alternatively, at least one of the components can be incorporated into the composition by feeding it directly into the extruder at the throat and/or downstream through a side stuffer. Additives can also be compounded into a masterbatch with a desired polymeric resin and fed into the extruder. The extruder is generally operated at a temperature higher than that necessary to cause the composition to flow. The extrudate is immediately quenched in a water bath and pelletized. The pellets can be one-fourth inch long or less as described. Such pellets can be used for subsequent molding, shaping or forming.

Melt blending methods are preferred due to the availability of melt blending equipment in commercial polymer processing facilities.

Illustrative examples of equipment used in such melt processing methods include co-rotating and counter-rotating extruders, single screw extruders, co-kneaders, and various other types of extrusion equipment.

The temperature of the melt in the processing is preferably minimized in order to avoid excessive degradation of the polymers. It is often desirable to maintain the melt temperature between 220° C. and 320° C. in the molten resin composition, although higher temperatures can be used provided that the residence time of the resin in the processing equipment is kept short.

In some cases, the melting composition exits from a processing equipment such as an extruder through small exit holes in a die. The resulting strands of the molten resin are cooled by passing the strands through a water bath. The cooled strands can be chopped into small pellets for packaging and further handling.

### Shaped Articles

The polycarbonate compositions according to the present invention can be used, for example for the production of various types of shaped articles.

In the second aspect, the present invention also provides a shaped article made from a polycarbonate composition according to the first aspect of the present invention.

As examples of such shaped articles mention can be made of those used in housing parts of electrical and electronics, for example, e.g. printers, copiers, chargers, TV projectors, notebook, pad, game consoles, etc.

### Preparation of Shaped Articles

The polycarbonate compositions according to the present invention can be processed into shaped articles by a variety of means such as injection moulding, extrusion moulding, blow moulding or thermoforming to form shaped articles.

In the third aspect, the present invention provides a process for preparing the shaped article made from a composition according to the first aspect of the present invention, comprising injection moulding, extrusion moulding, blow moulding or thermoforming the polycarbonate composition according to the present invention.

### EXAMPLES

The present invention will be illustrated in detail below with reference to the examples below. The examples are only for the purpose of illustration, rather than limiting the scope of the present invention.

### Materials Used

### Component A

PC-1: available from the company Covestro Polymer (China), a linear polycarbonate based on bisphenol A have a weight average molecular weight of 26000 g/mol, as determined by means of Gel Permeation Chromatography (GPC) in methylene chloride at 25° C. using a polycarbonate standard.

PC-2: available from the company Covestro Polymer (China), a linear polycarbonate based on bisphenol A having a weight average molecular weight (Mw) of 24000 g/mol, as determined by means of Gel Permeation Chromatography (GPC) in methylene chloride at 25° C. using a polycarbonate standard.

### Component B

BDP: bisphenol-A bis(diphenyl phosphate), available from the company Zhejiang Wansheng Science China.

### Component C

ABS: produced by emulsion polymerisation of 42-45 wt. %, based on the ABS polymer, of a mixture of 27 wt. % acrylonitrile and 73 wt. % styrene in the presence of 55-58 wt. %, based on the ABS polymer, of a crosslinked polybutadiene rubber, available as ABS HRG powder P60 from Styrolution.

MBS: Methyl methacrylate-butadiene-styrene, available as Kane Ace M732 from the company Japan Kaneka Chemical Co., Ltd.

S-2130: Silicone-acrylic rubber based impact modifier, available as Metablen S-2130 from the company Mitsubishi Chemical Corporation.

S-2100: Silicone-acrylic rubber based impact modifier, available as Metablen S-2100 from the company Mitsubishi Chemical Corporation.

### Component D

Kaolin: available as Polyfil HG90 with a median particle size of 0.4 μm from KaMin LLC.

Talc: available as ultra5C with a median diameter of 0.65 μm from IMI Fabi LLC.

### Component E

PTFE-SAN: Anti-dripping agent, polytetrafluoroethylene (PTFE) capped by styrene-acrylonitrile copolymer (SAN) with a weight ratio of PTFE:SAN=1:1, available as ADS5000 from IRPC Public Company Limited.

### Other Components

PETS: pentaerythritol tetrastearate, a demolding agent, available as FACI L348 from FACI Asia Pacific Pte Ltd (Singapore).

Irganox® B900: a mixture of 80% Irgafos® 168 and 20% Irganox® 1076 available from the company BASF, wherein Irgafos®168 is (tris (2,4-di-tert-butylphenyl)phosphite), Irganox® 1076 is (2,6-di-tert-butyl-4-(octadecanoxy-carbonylethyl)-phenol.

### Test Methods

The physical properties of specimens in the examples were tested as follows.

### Izod Notched Impact Strength

Izod notched impact strength was measured on specimens with dimensions of 80 mm×10 mm×4 mm according to IS0180/1A:2000 (23° C., 4 mm, 5.5 J).

### Buring Behavior

UL 94 @1.5 mm: measured on 125 mm×12.5 mm bars with 1.5 mm thickness according to UL94:2015.

UL 94 5VB@2.0 mm:

In the UL94 vertical burn tests, a flame was applied to a vertically fastened 125 mm×12.5 mm specimen with a thickness of 2.0 mm (which has been stored at 23° C. for 2 days) placed above a cotton wool pad. if burning was stop within 60 seconds after five applications of a flame to the specimen, and there is no drips that ignite the pad, then the specimen will be deemed to achieve a rating of 5VB, and the test will be classified as “Pass”, otherwise, the test will be classified as “Fail”.

### Comparative Examples (CE) 1-7 and Invention Examples (IE) 1-5

The materials listed in Table 1 were compounded on a twin-screw extruder (ZSK-26) (from Coperion, Werner and Pfleiderer) at a speed of rotation of 225 rpm, a throughput of 30 kg/h, and a machine temperature of 240° C.-290° C. and granulated.

The pellets obtained were processed into corresponding testing specimens on an injection moulding machine (from Arburg) with a melting temperature of 240-300° C. a mold temperature of 80° C., and a flow front velocity 240 mm/s.

The properties (including Izod notched impact strength and burning behavior) of the molded parts based on compositions obtained were tested and the results were summarized in Table 1.

It can be seen from Table 1 that the molded part based on comparative example 1, comprising 0.2 wt. % of PTFE (which correspond to 0.4 wt. % of PTFE-SAN masterbatch) and 8 wt. % of acrylonitrile-butadiene-styrene and not comprising a second impact modifier and a mineral filler, has a flame retardant level of V0 in the UL 94 @1.5 mm test and can pass the UL 94 5VB@2.0 mm test.

The molded part based on comparative example 2, comprising 0.125 wt % of PTFE (which correspond to 0.25 wt. % of PTFE masterbatch) and 8 wt. % of acrylonitrile-butadiene-styrene and not comprising a second impact modifier and a mineral filler, cannot pass the UL 94 5VB@2.0 mm test.

The molded part based on comparative example 3, comprising 8 wt. % of acrylonitrile-butadiene-styrene and not comprising a second impact modifier and a mineral filler, has a flame retardant level of V1 in the UL 94 @1.5 mm test and cannot pass the UL 94 5VB@2.0 mm test.

The molded parts based on comparative examples 4-6, not comprising a mineral filler, cannot pass the UL 94 5VB@2.0 mm test.

The molded part based on comparative example 7, comprising 8 wt. % of silicone-acrylic rubber based impact modifier and not comprising a mineral filler, cannot pass the UL 94 5VB@2.0 mm test.

The molded parts based on invention examples 1-5, comprising the combination of ABS P60 and Metablen S-2130 along with a mineral filler Kaolin, have an Izod notched impact strength of at least 36 kJ/m², a flame retardant level of V0 in the UL 94 @1.5 mm test and can pass the UL 94 5VB@2.0 mm test.

TABLE 1

| | CE1 | CE2 | CE3 | CE4 | CE5 | CE6 | CE7 | IE1 | IE2 | IE3 | IE4 | IE5 |
|---|---|---|---|---|---|---|---|---|---|---|---|---|
| Components | Wt. % | Wt. % | Wt. % | Wt. % | Wt. % | Wt. % | Wt. % | Wt. % | Wt. % | Wt. % | Wt. % | Wt. % |
| PC-1 | 38.80 | 38.80 | 38.80 | 38.80 | 38.80 | 38.80 | 38.80 | 38.80 | 38.80 | 38.80 | 38.8 | 38.80 |
| PC-2 | 35.30 | 35.45 | 35.52 | 35.52 | 35.52 | 35.52 | 35.52 | 34.52 | 33.52 | 33.52 | 31.52 | 29.52 |
| BDP | 17.00 | 17.00 | 17.00 | 17.00 | 17.00 | 17.00 | 17.00 | 17.00 | 17.00 | 17.00 | 17.00 | 17.00 |
| ABS | 8 | 8 | 8 | 6 | 4 | 2 | | 4 | 6 | 2 | 4 | 4 |
| S-2130 | | | | 2 | 4 | 6 | 8 | 4 | 2 | 6 | 4 | 4 |
| PTFE-SAN | 0.40 | 0.25 | 0.18 | 0.18 | 0.18 | 0.18 | 0.18 | 0.18 | 0.18 | 0.18 | 0.18 | 0.18 |
| Kaolin | | | | | | | | 1 | 2 | 2 | 4 | 6 |
| Izod notched | 44 | 47 | 45 | 43 | 47 | 45 | 47 | 44 | 39 | 44 | 40 | 36 |
| impact strength | | | | | | | | | | | | |
| (kJ/m²) | | | | | | | | | | | | |
| UL 94 @1.5 mm | V0 | V0 | V1 | V0 | V0 | V0 | V0 | V0 | V0 | V0 | V0 | V0 |
| UL 94 | Pass | Fail | Fail | Fail | Fail | Fail | Fail | Pass | Pass | Pass | Pass | Pass |
| 5VB@2.0 mm | | | | | | | | | | | | |

### Comparative Examples (CE) 8-12 and Invention Examples (IE) 6-13

Similarly, the materials listed in Table 2 were compounded, the properties of the molded parts based on compositions obtained were tested and the results were summarized in Table 2.

It can be seen from Table 2 that the molded parts based on comparative examples 8-11, comprising a combination of ABS P60 and MBS Kane Ace M732 or Metablen S-2100, not comprising a mineral filler, cannot pass the UL 94 5VB@2.0 mm test.

The molded part based on comparative example 12, comprising 8 wt. % of methyl methacrylate-butadiene-styrene and not comprising a second impact modifier and a mineral filler, cannot pass the UL 94 5VB@2.0 mm test.

The molded parts based on invention examples 6-13, comprising a combination of ABS P60 and MBS Kane Ace M732 or Metablen S-2100 along with a mineral filler Kaolin, have an Izod notched impact strength of at least 22 kJ/m², a flame retardant level of V0 in the UL 94 @1.5 mm test and can pass the UL 94 5VB@2.0 mm test.

TABLE 2

| | CE8 | CE9 | CE10 | CE11 | CE12 | IE6 | IE7 | IE8 | IE9 | IE10 | IE11 | IE12 | IE13 |
|---|---|---|---|---|---|---|---|---|---|---|---|---|---|
| Components | Wt. % | Wt. % | Wt. % | Wt. % | Wt. % | Wt. % | Wt. % | Wt. % | Wt. % | Wt. % | Wt. % | Wt. % | Wt. % |
| PC-1 | 38.80 | 38.80 | 38.80 | 38.80 | 38.80 | 38.80 | 38.80 | 38.80 | 38.80 | 38.80 | 38.80 | 38.80 | 38.80 |
| PC-2 | 35.52 | 35.52 | 35.52 | 35.52 | 35.52 | 33.52 | 33.52 | 33.52 | 31.52 | 33.52 | 33.52 | 33.52 | 31.52 |
| BDP | 17 | 17 | 17 | 17 | 17 | 17 | 17 | 17 | 17 | 17 | 17 | 17 | 17 |
| ABS | 4 | 6 | 4 | 2 | | 6 | 4 | 2 | 4 | 6 | 4 | 2 | 4 |
| MBS | | 2 | 4 | 6 | 8 | 2 | 4 | 6 | 4 | | | | |
| S-2100 | 4 | | | | | | | | | 2 | 4 | 6 | 4 |
| PTFE-SAN | 0.18 | 0.18 | 0.18 | 0.18 | 0.18 | 0.18 | 0.18 | 0.18 | 0.18 | 0.18 | 0.18 | 0.18 | 0.18 |
| Kaolin | | | | | | 2 | 2 | 2 | 4 | 2 | 2 | 2 | 4 |
| Izod notched | 37 | 37 | 34 | 26 | 31 | 36 | 28 | 22 | 29 | 41 | 46 | 43 | 40 |
| impact strength | | | | | | | | | | | | | |
| (kJ/m²) | | | | | | | | | | | | | |
| UL 94 @1.5 mm | V0 | V0 | V0 | V0 | V0 | V0 | V0 | V0 | V0 | V0 | V0 | V0 | V0 |
| UL 94 5VB@ 2.0 mm | Fail | Fail | Fail | Fail | Fail | Pass | Pass | Pass | Pass | Pass | Pass | Pass | Pass |

### Comparative Examples (CE) 13-15 and Invention Examples (IE) 14-17

Similarly, the materials listed in Table 3 were compounded, the properties of the molded parts based on compositions obtained were tested and the results were summarized in Table 3.

TABLE 3

| | CE13 | CE14 | CE15 | IE14 | IE15 | IE16 | IE17 |
|---|---|---|---|---|---|---|---|
| Components | Wt. % | Wt. % | Wt. % | Wt. % | Wt. % | Wt. % | Wt. % |
| PC-1 | 38.80 | 38.80 | 38.80 | 38.80 | 38.80 | 38.80 | 38.80 |
| PC-2 | 30.52 | 33.52 | 33.52 | 34.52 | 33.52 | 31.52 | 33.52 |
| BDP | 17 | 17 | 17 | 17 | 17 | 17 | 17 |
| ABS | 8 | 8 | | 4 | 4 | 4 | 4 |
| MBS | | | 8 | | | | |
| S-2130 | | | | 4 | 4 | 4 | |
| S-2100 | | | | | | | 4 |
| PTFE-SAN | 0.18 | 0.18 | 0.18 | 0.18 | 0.18 | 0.18 | 0.18 |
| Kaolin | 5 | | 2 | | | | |
| Talc | | 2 | | 1 | 2 | 4 | 2 |
| Izod notched impact | 32 | 29 | 9.0 | 40 | 35 | 24 | 31 |
| strength (kJ/m²) | | | | | | | |
| UL 94 @1.5 mm | V0 | V0 | V0 | V0 | V0 | V0 | V0 |
| UL 94 5VB@2.0 mm | Fail | Fail | Pass | Pass | Pass | Pass | Pass |

It can be seen from Table 3 that the molded parts based on comparative examples 13-14, not comprising the combination of acrylonitrile-butadiene-styrene and a second impact modifier is selected from methyl methacrylate-butadiene-styrene and silicone-acrylic rubber based impact modifiers, cannot pass the UL 94 5VB@2.0 mm test.

The molded part based on comparative example 15, not comprising the combination of methyl methacrylate-butadiene-styrene and a second impact modifier is selected from acrylonitrile-butadiene-styrene and silicone-acrylic rubber based impact modifiers, has an Izod notched impact strength of lower than 10 kJ/m².

The molded parts based on invention examples 14-17, comprising a combination of ABS P60 and Metablen S-2130 or Metablen S-2100 along with a mineral filler Talc, have an Izod notched impact strength of at least 24 kJ/m², a flame retardant level of V0 in the UL 94 @1.5 mm test and can pass the UL 94 5VB@2.0 mm test.

### Comparative Example (CE) 16 and Invention Examples (IE) 18-24

Similarly, the materials listed in Table 4 were compounded, the properties of the molded parts based on compositions obtained were tested and the results were summarized in Table 4.

TABLE 4

| | CE16 | IE18 | IE19 | IE20 | IE21 | IE22 | IE23 | IE24 |
|---|---|---|---|---|---|---|---|---|
| Components | Wt. % | Wt. % | Wt. % | Wt. % | Wt. % | Wt. % | Wt. % | Wt. % |
| PC-1 | 38.80 | 38.80 | 38.80 | 38.80 | 38.80 | 38.80 | 40.80 | 38.80 |
| PC-2 | 29.62 | 29.55 | 29.58 | 29.55 | 27.55 | 36.52 | 31.52 | 29.52 |
| BDP | 17 | 17 | 17 | 17 | 17 | 17 | 15 | 17 |
| ABS | 4 | 4 | 4 | 4 | 5 | 3 | 4 | 5 |
| S-2130 | 4 | 4 | 4 | | 5 | 3 | 4 | 5 |
| S-2100 | | | | 4 | | | | |
| PTFE-SAN | 0.08 | 0.15 | 0.12 | 0.15 | 0.15 | 0.18 | 0.18 | 0.18 |
| Kaolin | 6 | 6 | 6 | 6 | 6 | 1 | 4 | 4 |
| Izod notched impact | 32 | 33 | 32 | 32 | 39 | 30 | 43 | 46 |
| strength ((kJ/m²) | | | | | | | | |
| UL 94 @1.5 mm | V0 | V0 | V0 | V0 | V0 | V0 | V0 | V0 |
| UL 94 5VB@2.0 mm | Fail | Pass | Pass | Pass | Pass | Pass | Pass | Pass |

It can be seen from Table 4 that the molded part based on comparative example 16, comprising 0.04 wt % of PTFE (which correspond to 0.08 wt. % of PTFE masterbatch), cannot pass the UL 94 5VB@2.0 mm test.

The molded parts based on invention examples 18-21, comprising low PTFE masterbatch loadings from 0.12 wt. % to 0.15 wt. % and combinations of ABS P60 and Metablen S-2130 or S-2100 along with 6 wt. % Kaolin, have an Izod notched impact strength of at least 32 kJ/m², a flame retardant level of V0 in the UL 94 @1.5 mm test and can pass the UL 94 5VB@2.0 mm test.

The molded parts based on invention examples 21-24, comprising combinations of ABS P60 and Metablen S-2130 with total impact modifier loading from 6 wt. % to 10 wt. %, along with from 1 wt. % to 6 wt. % Kaolin, have an Izod notched impact strength of at least 30 kJ/m2, a flame retardant level of V0 in the UL 94 @1.5 mm test and can pass the UL 94 5VB@2.0 mm test.

Above results show there is obvious synergies with impact modifiers combinations and mineral fillers according to the present invention, which can result in good FR performance (V0@1.5 mm and 5VB@2.0 mm) at low PTFE % (<1000 ppm). This provides solutions to potential regulation change regarding fluorinated compounds.

1: A polycarbonate composition comprising the following components, relative to the total weight of the composition:
A) 63-81 wt. % of an aromatic polycarbonate,
B) 13-20 wt. % of a phosphorus flame retardant,
C) 4-12 wt. % of impact modifiers containing 1-7 wt. % of a first impact modifier and 1-7 wt. % a second impact modifier, wherein the first impact modifier is acrylonitrile-butadiene-styrene, and the second impact modifier is selected from methyl methacrylate-butadiene-styrene and silicone-acrylic rubber based impact modifiers,
D) 1-6 wt. % of a mineral filler, and
E) 0.05-0.09 wt. % of polytetrafluoroethylene.

2: The polycarbonate composition according to claim 1, wherein the phosphorous-containing flame retardant is selected from phosphorus compounds of formula (A): 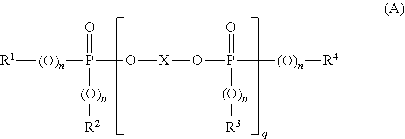
wherein
R¹, R², R³ and R⁴, independently of one another, each denotes optionally halogenated C1-C8 alkyl, C5-C6 cycloalkyl, C6-C20 aryl or C7-C12 aralkyl each optionally substituted by alkyl, preferably C1-C4 alkyl, and/or halogen, preferably chlorine, bromine,
n independently of one another, denotes 0 or 1,
q denotes a number ranging from 0 to 30, and
X denotes a mononuclear or polynuclear aromatic residue with 6 to 30 carbon atoms or a linear or branched aliphatic residue with 2 to 30 carbon atoms, which can be OH-substituted and can contain up to eight ether bonds.

3: The polycarbonate composition according to claim 2, wherein the phosphorous-containing flame retardant is selected from tributyl phosphate, triphenyl phosphate, tricresyl phosphate, diphenyl cresyl phosphate, diphenyl octyl phosphate, diphenyl-2-ethylcresyl phosphate, tri(isopropylphenyl)phosphate, resorcinol bridged oligophosphate, bisphenol A bridged oligophosphate, and combinations thereof.

4: The polycarbonate composition according to claim 1, wherein the phosphorous-containing flame retardant is selected from bisphenol A bis(diphenyl phosphate), tetraphenyl resorcinol diphosphate, [1,3-phenylene-tet-rakis(2,6-dimethylphenyl)phosphate], and combinations thereof.

5: The polycarbonate composition according to claim 1, wherein the silicone-acrylate rubber based impact modifier is selected from (meth)acrylic acid (C₁-C₈)-alkyl ester-grafted silicone-C₁-C₈ alkyl acrylate rubber.

6: The polycarbonate composition according to claim 5, wherein the silicone-acrylate rubber based impact modifier is a methyl methacrylate-grafted silicone-butyl acrylate rubber.

7: The polycarbonate composition according to claim 1, wherein the composition comprises from 2 wt. % to 6 wt. % of acrylonitrile-butadiene-styrene and from 2 wt. % to 6 wt. % of of methyl methacrylate-butadiene-styrene.

8: The polycarbonate composition according to claim 1, wherein the composition comprises from 2 wt. % to 6 wt. % of acrylonitrile-butadiene-styrene and from 2 wt. % to 6 wt. % of methyl methacrylate-grafted silicone-butyl acrylate rubber.

9: The polycarbonate composition according to claim 1, wherein the mineral filler is selected from mica, talc, wollastonite, silica, kaolin, inorganic whiskers, boron nitride, and combinations of two or more thereof.

10: The polycarbonate composition according to claim 1, wherein the mineral filler is selected from mica, talc, wollastonite, silica, kaolin, and combinations of two or more thereof.

11: The polycarbonate composition according to claim 1, wherein the mineral filler is kaolin.

12: Composition according to claim 1, comprising, relative to the total weight of the composition:
A) 66-76 wt. % of an aromatic polycarbonate based on bisphenol A,
B) 14-18 wt. % of a phosphorous flame retardant selected from bisphenol A bis(diphenyl phosphate), tetraphenyl resorcinol diphosphate, and [1,3-phenylene-tet-rakis(2,6-dimethylphenyl)phosphate],
C) 2-6 wt. % of acrylonitrile-butadiene-styrene and 2-6 wt. % of an impact modifier selected from methyl methacrylate-butadiene-styrene and methyl methacrylate-grafted silicone-butyl acrylate rubber,
D) 1-5 wt. % of kaolin, and
E) 0.05-0.09 wt. % of polytetrafluoroethylene.

13: Composition according to claim 1, wherein the total amount of components A)-E) as defined above is from 90 wt. % to 100 wt. %, based on the total weight of the polycarbonate composition according to the present invention.

14: A shaped article made from the composition according to claim 1.
